(19) United States
(12) Patent Application Publication
(10) Pub. No.: US 2009/0325694 A1
(43) Pub. Date: Dec. 31, 2009

(54) MACROSCOPIC QUANTUM EFFECTS FOR COMPUTER GAMES

(75) Inventors: Brian C. Beckman, Newcastle, WA (US); Mohsen M. Agsen, Honolulu, HI (US); Momin Mahmoud Al-Ghosien, Sammamish, WA (US)

Correspondence Address: MICROSOFT CORPORATION, ONE MICROSOFT WAY, REDMOND, WA, 98052, US

(73) Assignee: MICROSOFT CORPRATION, Redmond, WA (US)

(21) Appl. No.: 12/147,628

(22) Filed: Jun. 27, 2008

(51) Int. Cl. A63F 13/00

(52) U.S. Cl. 463/31

(57) ABSTRACT

The claimed subject matter provides a system and/or a method that facilitates providing a realistic simulation within a gaming environment. A gaming environment can enable at least one user to interact with a computer game in order to produce visual feedback in which the computer game includes a simulation that mimics an event in a physical real world. A macroscopic quantum effects (MQE) engine can utilize quantum physics as a basis for at least one simulation within the gaming environment, wherein the MQE engine leverages an equation related to quantum physics which enables the simulation to replicate a property associated with realistic quantum mechanics. An interface can allow data communication between the gaming environment and the MQE engine.

### BACKGROUND

Technological advances in computer hardware, software and networking have lead to increased demand for electronic information exchange rather than through conventional techniques such as paper correspondence, for example. Such electronic communication can provide split-second, reliable data transfer between essentially any two locations throughout the world. Many industries and consumers are leveraging such technology to improve efficiency and decrease cost through web-based (e.g., on-line) services. For example, consumers can purchase goods, review bank statements, research products and companies, obtain real-time stock quotes, download brochures, etc. with the click of a mouse and at the convenience of home.

In particular, modern game-play devices have developed capabilities of powerful computers as integrated circuit technology has become more advanced and incorporated into such game-play devices. Where traditional game-play devices ran exclusively on removable media, such as floppy discs, compact discs (CDs), digital video discs (DVDs), etc., and interaction with such games was solely by way of a joystick or other game control device, modern game-play systems are not so limited. Rather, a modern device can utilize powerful network and computing applications such as e-mail, instant messaging, web browsing, digital video recording, and the like. Additionally, gaming has progressed to an online arena, where players can synchronize their gaming systems with other players via an online server, and communicate, coordinate, and interface with other remote players while playing a game.

The gaming industry has followed technological advances and has quickly adapted to become realistic in graphics, game play, dynamics, and even physics. Generally, games typically attempt to achieve the most realistic interaction in order to provide a user with a heightened level of game play. For example, throwing an object within a video game typically mimics the throwing of the same object in the real world (e.g., arm motion, flight of object, laws of physics, gravity, distance traveled, speed, wind interaction with the object, etc.). Regardless of game type, gaming console, gaming system, gaming format, etc., users/players typically judge the success of a game by manner of evaluating realism.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate incorporating a combination of classical physics and quantum physics into a gaming environment in order to increase realism of simulations, effects, skills, situations, etc. A macroscopic quantum effects (MQE) engine can leverage a quantum physics equation in order to base the behavior of a simulation within a gaming environment. In other words, a simulation such as, for instance, a projectile, a vehicle, a collision, an explosion, a fantasy element, a magical spell, or a science-fiction weapon can have behavior or properties defined by quantum physics. In a particular aspect, the MQE engine can adjust an “h-bar” value and/or a “c” value associated with an equation related to quantum physics in order to have a portion of the quantum effect spectrum to become visible macroscopically.

Generally, the MQE engine can increase the plausibility of a simulation, wherein the plausibility of a simulation or elements within the gaming environment can be increased in terms of having more realistic physics even though the simulations or elements may be potentially unrealistic or fantasy-based. By increasing plausibility for a computer game simulation or event, the excitement, attractiveness, appeal, drama, thrill, look, and feel can be improved. In other aspects of the claimed subject matter, methods are provided that facilitate incorporating a classical physics theory, a quantum mechanics physics theory, or a combination thereof within a gaming environment.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates incorporating quantum physics related simulations within a gaming environment.

FIG. 2 illustrates a block diagram of an exemplary system that facilitates leveraging a quantum physics library for implementation within a gaming environment.

FIG. 3 illustrates a block diagram of an exemplary system that facilitates utilizing classical physics and/or quantum physics within a gaming environment.

FIG. 4 illustrates a block diagram of an exemplary system that facilitates replicating an effect within a gaming environment based upon a theory associated with macroscopic quantum effects.

FIG. 5 illustrates a block diagram of an exemplary system that facilitates incorporating physic simulations within a gaming environment.

FIG. 6 illustrates an exemplary methodology for incorporating a classical physics theory, a quantum mechanics physics theory, or a combination thereof within a gaming environment.

FIG. 7 illustrates an exemplary networking environment, wherein the novel aspects of the claimed subject matter can be employed.

FIG. 8 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “environment,” “engine,” “cloud,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

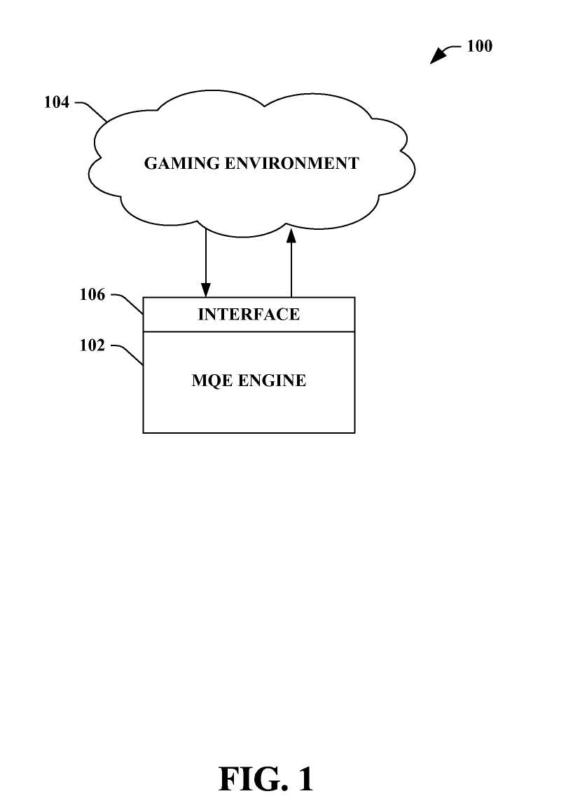

Now turning to the figures, FIG. 1 illustrates a system 100 that facilitates incorporating quantum-physics related simulations within a gaming environment. The system 100 can include a macroscopic quantum effects (MQE) engine 102 that can utilize quantum physics as a basis for a simulation associated with a gaming environment 104. In particular, the MQE engine 102 can leverage quantum physics and/or equations associated therewith in order to increase the reality/visual appeal of the gaming environment 104. The system 100 can further include an interface component 106 (herein referred to as the “interface 106”) can be utilized to communicate data seamlessly between the MQE engine 102 and the gaming environment 104.

The subject innovation can increase the visual appeal of effects within the gaming environment 104 as well as enhance the game-play experience with unreal but plausible effects based on the actual equations of quantum physics. Typically, quantum physics relates to microscopic level, but the system 100 can apply equations of quantum physics in a macroscopic context by increasing the value of parameters (e.g., h-bar-absolute constant determining scale size of quantum effects, etc.) to an unreal large (e.g., macroscopic) level, and decreasing the value of parameters (e.g., c-speed of light, etc.) to an unreal small level. By adjusting these parameters, quantum effects can be exposed from the microscopic world into the world of normal scale sizes (e.g., macroscopic). These effects can generate magical, fantasy effects in the gaming environment. Moreover, since these effects are based on real but microscopic physics, such effects can have an enhanced plausibility in contrast with ad-hoc magical fantasy effects, which, in the state of the art, are created by artists rather than by technical means, that is, rather than by physics and mathematics.

Generally, the MQE engine 102 can increase the plausibility of a simulation, wherein the simulation within the gaming environment 104 can relate to at least one of a projectile, a vehicle, a collision, an explosion, a fantasy element, a magical spell, or a science-fiction weapon. It is to be appreciated that the plausibility of a simulation or elements within the gaming environment 104 can be increased in terms of having more realistic-seeming physics even though the simulations or elements may be potentially unrealistic or fantasy-based. By increasing plausibility for a computer game simulation or event, the excitement, attractiveness, appeal, drama, thrill, look, and feel can be improved.

The gaming environment 104 can be any suitable environment, platform, device, console, etc. in which at least one user can interact with a computer game or video game to provide feedback (e.g., physical, visual, emotional, etc.). For example, the gaming environment 104 can be, but is not limited to being, a gaming device, a gaming console, a computer, a desktop machine, a laptop, a smartphone, a device with a portion of memory and a processor, a portable digital assistant (PDA), a hand held, a portable gaming device, an online community, a website, a server, a network, a cloud, a media player, etc.

For example, a computer game or video game can include a controller (e.g., joystick, keyboard, button input, accelerometer, motion detector/sensor, etc.) in which a user can interact with graphics displayed on a screen (e.g., monitor, television, flat-screen, plasma screen, liquid crystal display (LCD), etc.). The user can interact with such graphics that depict, for instance, objects, environments, items, characters, and the like. Thus, the graphics depicted can portray events, simulations, etc. in which the MQE engine 102 can utilize quantum physics to portray such events, simulations, etc. with realistic physic characteristics/properties.

In addition, the system 100 can include any suitable and/or necessary interface 106, which provides various adapters, application programming interfaces (APIs), connectors, channels, communication paths, etc. to integrate the MQE engine 102 into virtually any operating and/or database system(s) and/or with one another. In addition, the interface 106 can provide various adapters, connectors, channels, communication paths, etc., that provide for interaction with the MQE engine 102, the gaming environment 104, and any other device and/or component associated with the system 100.

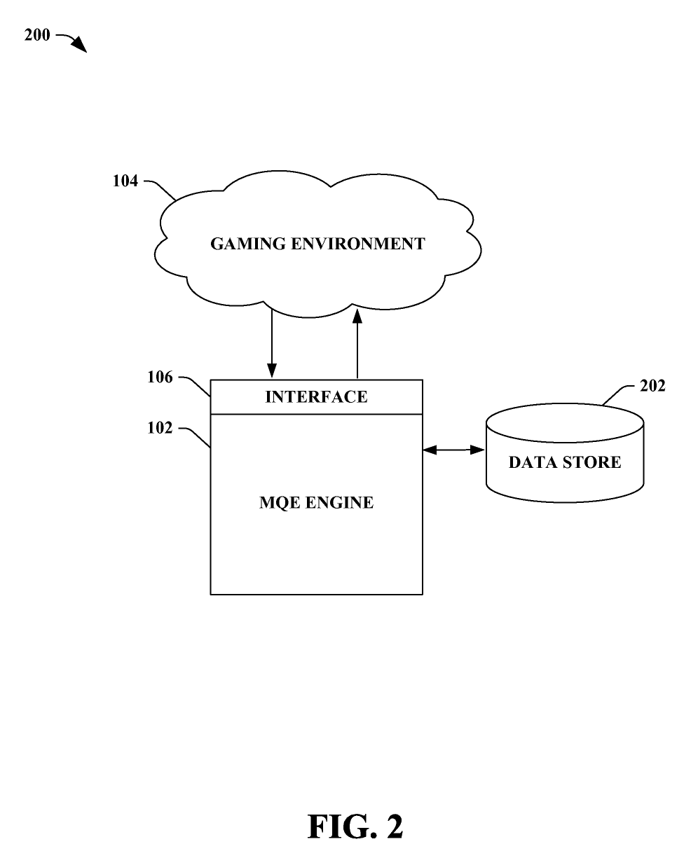

FIG. 2 illustrates a system 200 that facilitates leveraging a quantum physics library for implementation within a gaming environment. The system 200 can include the macroscopic quantum effects (MQE) engine 102 that enables an event, effect, simulation, or skill within a computer game or video game associated with the gaming environment 104 to replicate characteristics or properties of an equation associated with at least one of quantum physics, quantum mechanics, or a quantum physics theory. In other words, standard quantum physics equations can be applied to macroscopic phenomena, events, simulations, skills, effects, etc. within the gaming environment 104.

The system 100 can further include a data store 202. In a particular example, the data store 202 can be a physics library (e.g., classical physic equations, quantum physics equations, etc.) which can be suitable for general-purpose computing but pared-down for game applications. The quantum-physics library can be analogous in structure to standard game-physics libraries, but with many detailed differences. For instance, standard game-physics libraries deal with 6-dimensional dynamic state vectors whereas quantum physics libraries can deal with dynamic fields and with interaction matrices. In another example, the quantum physics library can be closely analogous to a fluid-mechanics library. Moreover, it is to be appreciated that the subject innovation can include any suitable APIs, interfaces, and the like to enable communication between any component, environment, engine and the data store 202.

The data store 202 can include any suitable data utilized or interacted with by the MQE engine 102, the gaming environment 104, the interface 106, etc. For example, the data store 202 can include, but not limited to including, standard physics library equations, quantum physics library equations, file formats (e.g., file formats for quantum-mechanical game asset, etc.), gaming environment data (e.g., video game data, computer game data, simulations, events, skills, effects, etc.), gaming controls, pairings of quantum physics to game events (e.g., which quantum physics equation can be based upon which skill or effect within a game, etc.), user profiles, user preferences, equation settings, etc.

It is to be appreciated that the data store 202 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 202 of the subject systems and methods is intended to comprise, without being limited to, these and any other suitable types of memory. In addition, it is to be appreciated that the data store 202 can be a server, a database, a hard drive, a pen drive, an external hard drive, a portable hard drive, and the like.

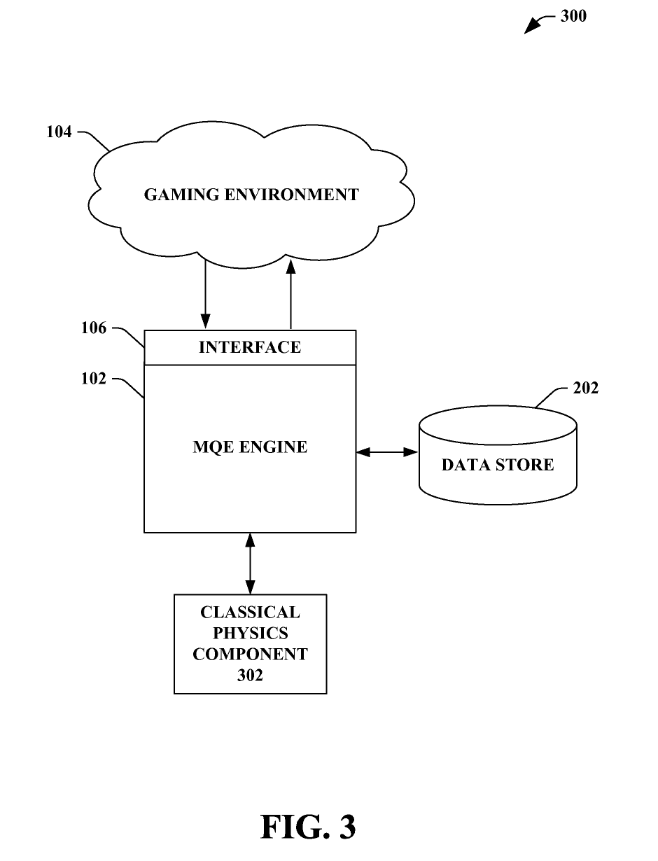

FIG. 3 illustrates a system 300 that facilitates utilizing classical physics and/or quantum physics within a gaming environment. The system 300 can include the macroscopic quantum effects (MQE) engine 102 that can leverage quantum physics equations in order to provide a simulation within the gaming environment 104 in which the simulation is substantially based upon characteristics/properties indicative of such equations. For instance, a simulation can relate to a projectile, a vehicle, a collision, an explosion, a fantasy element, a magical spell, or a science-fiction weapon. Such simulation can react or behave in accordance to quantum physics definitions or parameters.

The MQE engine 102 can incorporate quantum physics into the gaming environment 104 by leveraging, for instance, various quantum physics related equations. For example, the MQE engine 102 can utilize equations such as, but not limited to, Schroedinger's Equation, Dirac Equation, Klein-Gordon Equation, Yang-Mills Field Equation, Heisenberg formulation of matrix mechanics (e.g., an extension to scattering theory, etc.), and/or any other suitable quantum physics property, parameter, or reaction. In general, the following can be employed by the MQE engine 102 within the gaming environment 104, a “Multiple-Slit Experiment,” Collapsing the Wave Packet,” “Quantum Scattering Theory,” and/or “Quantum Entanglement.”

The MQE engine 102 can expand the typically ultramicroscopic related theories of quantum physics to the gaming environment 104. The scope and scale of the equations of quantum physics can depend on a couple of parameters, for instance, h-bar and c. For instance, the MQE engine 102 can increase the magnitudes of h-bar and decrease the magnitude of c in order to replicate the precise equations of quantum physics for a simulation or event but in a macroscopic context, that is, at size scales similar to those of other game elements subject to classical physics like vehicles and human figures, and at time scales similar to those of other game elements.

For example, a character can be running away from an adversary that is trying to shoot you within a video game or computer game. A barrier with multiple ways through can be in front of your path (e.g., the barrier can resemble a Roman aqueduct held aloft by a repeating pattern of masonry arches or a wall with multiple doorways). Within the game, a “Quantum Unreality Defense System” can be invoked to allow your character to decompose into a superposition of states, wherein such decomposition can enable the character to travel through all the archways at once. This technique can thwart the efforts of your adversary to target you. In particular, the visual effect in the game can be to see your character shimmer and become a wave-like apparition, which is then able to progress through the openings in the barrier with plausible-looking diffraction and wavelike interference effects. The tactical effect can be that your adversary cannot target your character. This technique or “Quantum Unreality Defense System” can replicate the “Multiple-Slit Experiment.” In another example, invocations of the defense can allow your character to “tunnel” out of deep wells, to pass through cyclone fences, teleport, fall safely from great heights, etc., with unprecedented degrees of plausibility (e.g., applying realistic physics in potentially unrealistic contexts).

In another example, the MQE engine 102 can apply quantum physics for an offensive side such as a “Quantum Unreality Offense System.” For instance, Quantum-enabled weapons can interact with superpositions of states, in which such states can be “collapsed” to eigenfunctions at inconvenient times, causing the defender to collide with the wall. Other applications of quantum physics in a video game, computer game, and/or gaming environment can include simulated “quantum computing” for at least one of in-game communication, cryptography, espionage, and data storage.

The MQE engine 102 can use the equations of quantum physics to perform unreal visual effects, simulations, and/or tactical effects. The MQE engine 102 can adjust the constants h-bar and c. When the h-bar is adjusted to a high level and c adjusted to a low level, the entire spectrum of quantum effects can become visible macroscopically. When the h-bar is adjusted to a low level and c adjusted to a high level, the gaming environment and objects within can go back to an ordinary realm of classical physics. It is to be appreciated that the adjustment of the h-bar and c can be user adjusted, manually adjusted, automatically adjusted, and/or any suitable combination thereof.

The MQE engine 102 can provide the application of quantum physics equations to macroscopic phenomena by changing the values of h-bar and c to yield a dramatic effect in the gaming environment 104 (e.g., video games, computer games, etc.). As mentioned, the MQE engine 102 can apply the “Multiple-Slit Experiment” effect—in other words, diffraction of the wave function—to defensive tactics and/or offensive tactics (e.g., a simulation within a video game, computer game, etc.) in the gaming environment 104. The MQE engine 102 can apply the “Collapsing the Wave Packet” to offensive tactics and/or defensive tactics (e.g., a simulation within a video game, computer game, etc.) in the gaming environment 104. In addition, the MQE engine 102 can provide the application of “Quantum Scattering Theory” to collision response in the gaming environment 104. Furthermore, the MQE engine 102 can invoke the application of “Quantum Entanglement” to at least one of an in-game communication, an action-at-a-distance (e.g., voodoo, etc.), a portion of cryptography, an instance of espionage, and/or data storage.

It is to be appreciated that the MQE engine 102 can enable the gaming environment to implement simulations that include classical physics, quantum physics, and/or any suitable combination thereof. In particular, the MQE engine 102 can include a classical physics component 302 that can employ classical physics (e.g., standard physics, classical mechanics, electrodynamics, fluid mechanics, etc.) to the gaming environment 104 for an event, a simulation, an effect, a visual, a skill, etc. The classical physics component 302 can update an object state within the gaming environment 104 by integrating Newton's or Lagrange's equations of motion. The classical physics component 302 can further check objects against one another in principle upon the detection of a collision within the gaming environment 104. With a collision, the classical physics component 302 can respond to collisions by at least one of backing objects up, applying compensating forces, applying reactive impulses, etc. Furthermore, the gaming environment 104 can display visible object (e.g., render scene, etc.) and/or collect user input (e.g., keyboard, mouse, game-pad buttons, on-screen interface elements, motion sensors, etc.).

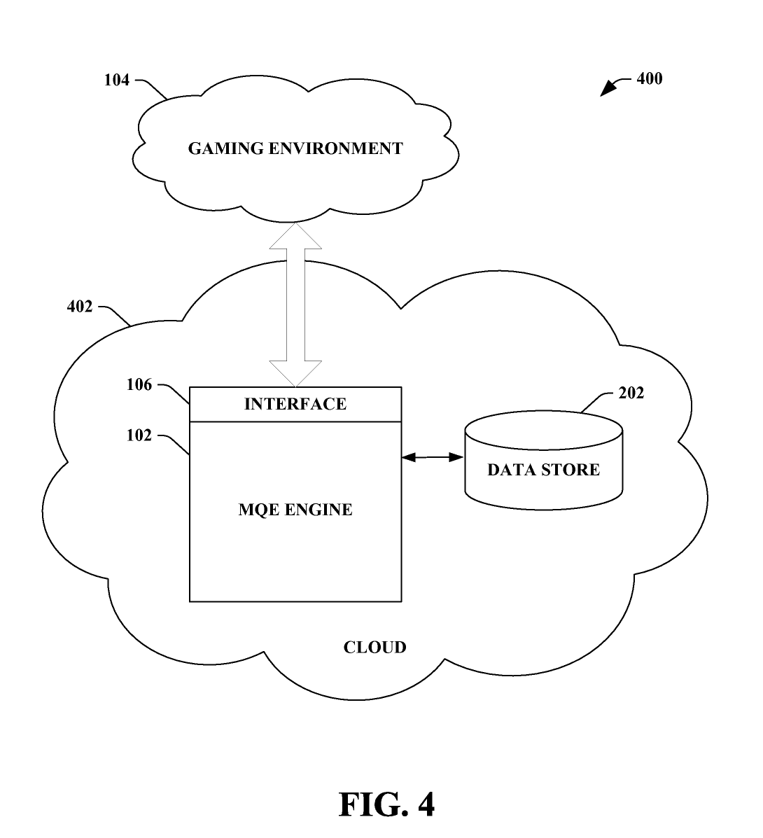

FIG. 4 illustrates a system 400 that facilitates replicating an effect within a gaming environment based upon a theory associated with macroscopic quantum effects. The system 400 can further utilize a cloud 402 that can incorporate at least one of the MQE engine 102, the gaming environment 104, the interface 106, the data store 202, and/or any suitable combination thereof. It is to be appreciated that the cloud 402 can include any suitable component, device, hardware, and/or software associated with the subject innovation. The cloud 402 can refer to any collection of resources (e.g., hardware, software, combination thereof, etc.) that are maintained by a party (e.g., off-site, on-site, third party, etc.) and accessible by an identified user over a network (e.g., Internet, wireless, LAN, cellular, Wi-Fi, WAN, etc.). The cloud 402 is intended to include any service, network service, cloud service, collection of resources, etc. and can be accessed by an identified user via a network. For instance, two or more users can access, join, and/or interact with the cloud 402 and, in turn, at least one of the MQE engine 102, the gaming environment 104, the interface 106, the data store 202, and/or any suitable combination thereof. In addition, the cloud 402 can provide any suitable number of service(s) to any suitable number of user(s) and/or client(s). In particular, the cloud 402 can include resources and/or services that incorporate quantum physics to simulations, events, effects, skills, tactics, and the like.

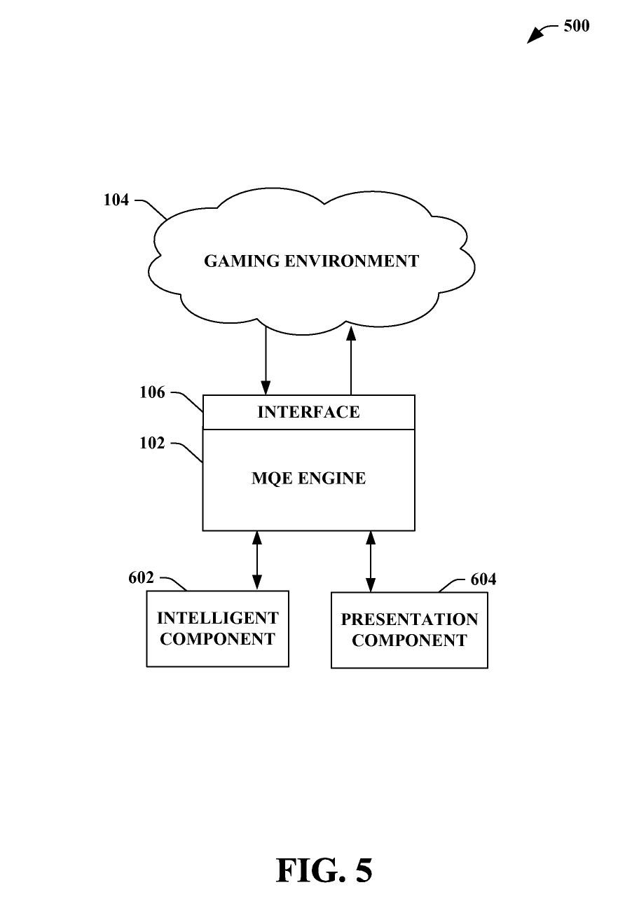

FIG. 5 illustrates a system 500 that facilitates incorporating physics simulations within a gaming environment. The system 500 can include the MQE engine 102, the gaming environment 104, and/or the interface 106, which can be substantially similar to respective engines, environments, and interfaces described in previous figures. The system 500 further includes an intelligent component 502. The intelligent component 502 can be utilized by the MQE engine 102 to invoking a simulation or effect based upon quantum physics within the gaming environment 104. For example, the intelligent component 502 can infer user preferences, h-bar values, c bar values, standard physics library equations, quantum physics library equations, file formats (e.g., file formats for quantum-mechanical game asset, etc.), pairings of quantum physics to game events (e.g., which quantum physics equation can be based upon which skill or effect within a game, etc.), user preferences, equation settings, equation definitions, etc.

The intelligent component 502 can employ value of information (VOI) computation in order to identify a most suited value for a variable related to a quantum physics equation for a particular situation in a gaming environment. For instance, by utilizing VOI computation, the most ideal and/or appropriate h-bar and c values can be identified and utilized. Moreover, it is to be understood that the intelligent component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The MQE engine 102 can further utilize a presentation component 504 that provides various types of user interfaces to facilitate interaction between a user and any component coupled to the MQE engine 102. As depicted, the presentation component 504 is a separate entity that can be utilized with the MQE engine 102. However, it is to be appreciated that the presentation component 504 and/or similar view components can be incorporated into the MQE engine 102 and/or a stand-alone unit. The presentation component 504 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the MQE engine 102.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

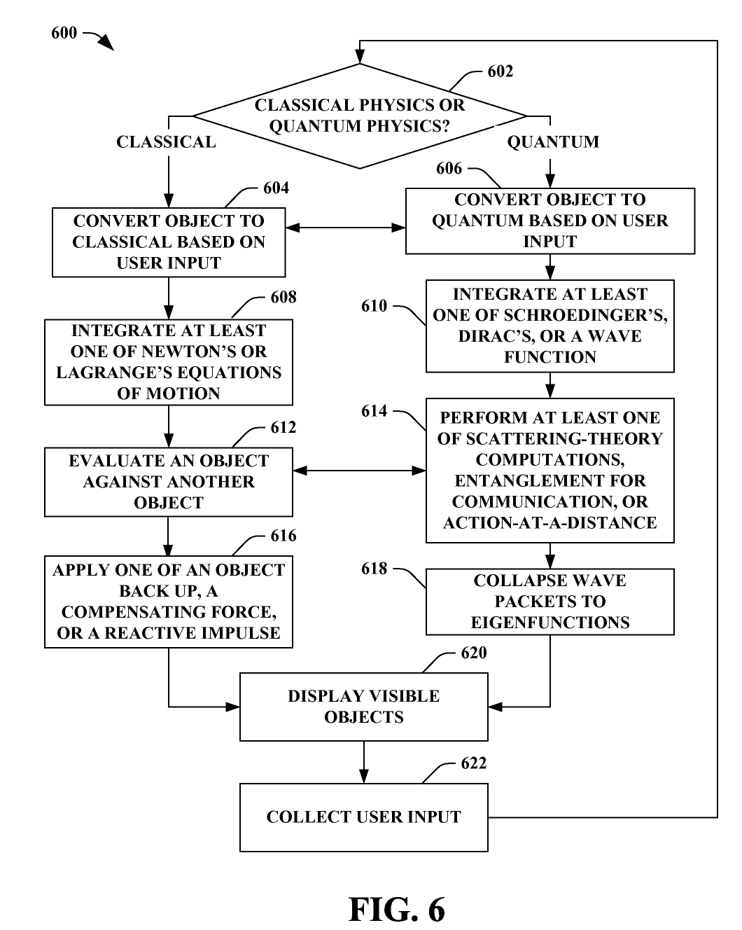

FIG. 6 illustrates a methodology and/or flow diagram in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 6 illustrates a methodology 600 for incorporating a classical physics theory, a quantum mechanics physics theory, or a combination thereof within a gaming environment. The methodology 600 can provide a classical physics for an object within a gaming environment, quantum physics for an object within a gaming environment, and/or any suitable combination thereof. In the following methodology 600, it is to be appreciated that an object can be converted from classical to quantum and back (e.g., also where creation and/or destruction can occur). Furthermore, it is to be appreciated that in the collision-detection reference numerals (e.g., reference numeral 608 and reference numeral 620), quantum waves can diffract from classical objects and classical objects can experience forces from quantum objects.

At reference numeral 602, a determination can be made whether an object within a gaming environment is to be treated with the characteristics or properties of classical physics or quantum physics. If the object is to be simulated or treated with classical physics, the methodology 600 can continue to reference numeral 604. At reference numeral 604, an object can be converted to classical. For example, this conversion can be based at least in part upon a user input. If the object is to be simulated or treated with quantum physics, the methodology 600 can continue to reference numeral 616. At reference numeral 606, an object can be converted to quantum. For example, this conversion can be based at least in part upon a user input. It is to be appreciated that the conversion (e.g., reference numeral 604 and/or 606) can be based upon, for instance, game events, formulas, scripts, artificial intelligence, etc.

At reference numeral 608, a classical object state can be updated. In particular, at reference numeral 608, at least one of Newton's equation of motion or Lagrange's equation of motion can be integrated to update the classical object. Following reference numeral 610, a quantum object state can be updated. In particular, at reference numeral 610, at least one of N-body Schroedinger's, Dirac's, or a wave function can be integrated to update the quantum object.

At reference numeral 612 and reference numeral 614, collisions can be detected. At reference numeral 612, classical object to classical object collisions can be detected, wherein in principle, an object can be checked against another object (e.g., each object can be checked against every other object, etc.). At reference numeral 614, a collision can be detected between classical and quantum, wherein at least one of Scattering-Theory computations, Entanglement for communication, or Action-at-a-Distance can be performed.

At reference numeral 616 and reference numeral 618, a response to collisions can be implemented. At reference numeral 616, one of the following can be applied for a classical object: an object back up, a compensating force, or a reactive impulse. At reference numeral 618, wave packets can be collapsed to Eigenfunctions for a quantum object.

Continuing to reference numeral 620, a scene can be rendered in which visible objects (e.g., classical objects, quantum object, etc.) can be displayed. At reference numeral 622, user input can be collected from, for example, a keyboard, a mouse, a game-pad button, an on-screen interface element, a motion sensor, etc. The methodology 600 can proceed to reference numeral 602 upon the completion of collecting a user input.

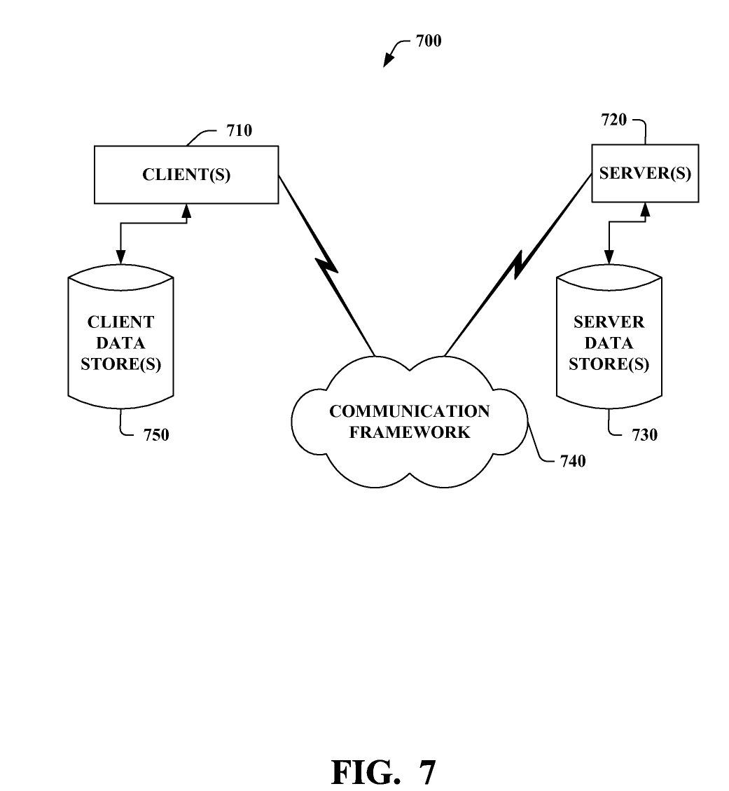

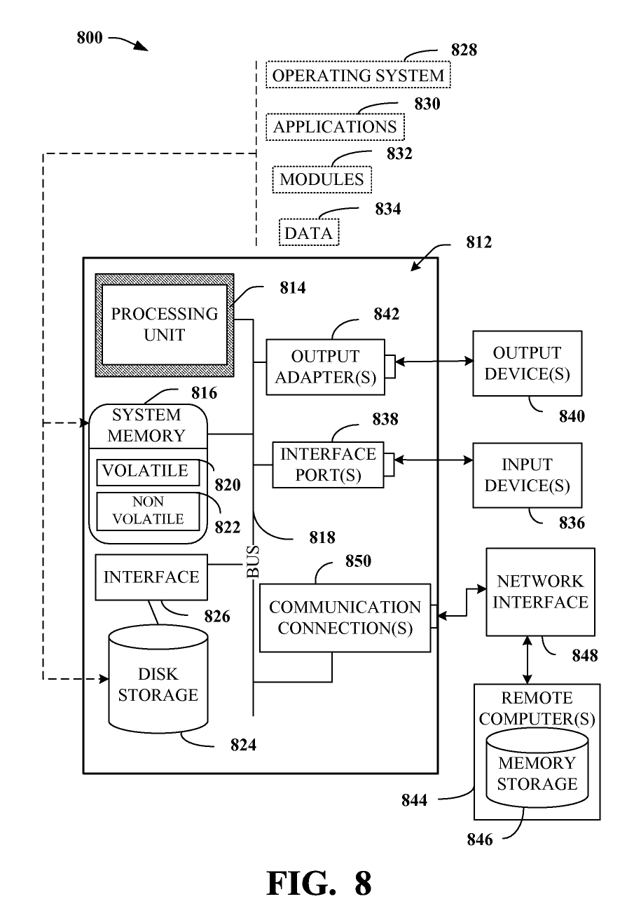

In order to provide additional context for implementing various aspects of the claimed subject matter, FIGS. 7-8 and the following discussion is intended to provide a brief, general description of a suitable computing environment in which the various aspects of the subject innovation may be implemented. For example, a macroscopic quantum effects (MQE) engine that can incorporate a simulation within a gaming environment based upon quantum mechanics, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 7 is a schematic block diagram of a sample-computing environment 700 with which the claimed subject matter can interact. The system 700 includes one or more client(s) 710. The client(s) 710 can be hardware and/or software (e.g., threads, processes, computing devices). The system 700 also includes one or more server(s) 720. The server(s) 720 can be hardware and/or software (e.g., threads, processes, computing devices). The servers 720 can house threads to perform transformations by employing the subject innovation, for example.

One possible communication between a client 710 and a server 720 can be in the form of a data packet adapted to be transmitted between two or more computer processes. The system 700 includes a communication framework 740 that can be employed to facilitate communications between the client(s) 710 and the server(s) 720. The client(s) 710 are operably connected to one or more client data store(s) 750 that can be employed to store information local to the client(s) 710. Similarly, the server(s) 720 are operably connected to one or more server data store(s) 730 that can be employed to store information local to the servers 720.

With reference to FIG. 8, an exemplary environment 800 for implementing various aspects of the claimed subject matter includes a computer 812. The computer 812 includes a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814.

The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 816 includes volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable programmable ROM (EEPROM), or flash memory. Volatile memory 820 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 812 also includes removable/non-removable, volatile/non-volatile computer storage media. FIG. 8 illustrates, for example a disk storage 824. Disk storage 824 includes, but is not limited to, devices like a magnetic disk drive, floppy disk drive, tape drive, Jaz drive, Zip drive, LS-100 drive, flash memory card, or memory stick. In addition, disk storage 824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 824 to the system bus 818, a removable or non-removable interface is typically used such as interface 826.

It is to be appreciated that FIG. 8 describes software that acts as an intermediary between users and the basic computer resources described in the suitable operating environment 800. Such software includes an operating system 828. Operating system 828, which can be stored on disk storage 824, acts to control and allocate resources of the computer system 812. System applications 830 take advantage of the management of resources by operating system 828 through program modules 832 and program data 834 stored either in system memory 816 or on disk storage 824. It is to be appreciated that the claimed subject matter can be implemented with various operating systems or combinations of operating systems.

A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port may be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a personal computer, a server, a router, a network PC, a workstation, a microprocessor based appliance, a peer device or other common network node and the like, and typically includes many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 850 refers to the hardware/software employed to connect the network interface 848 to the bus 818. While communication connection 850 is shown for illustrative clarity inside computer 812, it can also be external to computer 812. The hardware/software necessary for connection to the network interface 848 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates providing a realistic simulation within a gaming environment, comprising:
a gaming environment that enables at least one user to interact with a computer game in order to produce visual feedback, the computer game includes a simulation that mimics an event in a physical real world;
a macroscopic quantum effects (MQE) engine that utilizes quantum physics as a basis for at least one simulation within the gaming environment, the MQE engine leverages an equation related to quantum physics which enables the simulation to replicate a property associated with realistic quantum mechanics; and
an interface that allows data communication between the gaming environment and the MQE engine.

2. The system of claim 1, the gaming environment is at least one of a gaming device, a gaming console, a computer, a desktop machine, a laptop, a smartphone, a device with a portion of memory and a processor, a portable digital assistant (PDA), a hand held, a portable gaming device, an online community, a website, a server, a network, a cloud, or a media player.

3. The system of claim 1, the MQE engine increases the plausibility of a simulation, the simulation within the gaming environment relates to at least one of a projectile, a vehicle, a collision, an explosion, a fantasy element, a magical spell, or a science-fiction weapon.

4. The system of claim 3, the MQE engine increases the plausibility of the simulation by mimicking a behavioral characteristic of a portion of the simulation with a behavioral characteristic of a property of the quantum physics equation.

5. The system of claim 3, the equation is at least one of a Schroedinger's Equation, a Dirac Equation, a Klein-Gordon Equation, a Yang-Mills Field Equation, a Heisenberg formulation of matrix mechanics, or a Heisenberg formulation of matrix mechanic extension to scattering theory.

6. The system of claim 1, the MQE engine applies a quantum physics equation to employ at least one of an offensive tactic or a defensive tactic within the gaming environment.

7. The system of claim 6, the MQE engine applies a “Multiple-Slit Experiment” effect to an object within the gaming environment as at least one of the offensive tactic or the defensive tactic.

8. The system of claim 6, the MQE engine applies a “Collapsing a Wave Packet” to an object within the gaming environment as at least one of the offensive tactic or the defensive tactic.

9. The system of claim 6, the MQE engine applies a “Quantum Scattering Theory” to a collision between a first object and a second object within the gaming environment.

10. The system of claim 6, the MQE engine applies a “Quantum Entanglement” to at least one of an in-game communication within the gaming environment, an Action-at-a-Distance, a cryptography, an espionage, or a data storage.

11. The system of claim 1, the MQE engine adjusts at least one of an “h-bar” value or a “c” value within the equation related to quantum physics in order to adapt the quantum physics equation to the simulation within the gaming environment.

12. The system of claim 11, the MQE engine increases at least one of the “h-bar” value or the “c” value within the equation, the increase enables a portion of a spectrum of quantum effects to become visible macroscopically.

13. The system of claim 1, further comprising a classical physics component that utilizes classical physics as a basis for at least one simulation within the gaming environment, the simulation within the gaming environment relates to at least one of a projectile, a vehicle, a collision, an explosion, a fantasy element, a magical spell, or a science-fiction weapon.

14. The system of claim 1, further comprising a cloud that incorporates at least one of the collection component, the verification component, the data store, and/or the interface.

15. The system of claim 14, the cloud is a collection of resources maintained by a party and accessible by an identified user over a network.

16. A computer-implemented method that facilitates implementing a combination of classical physics and quantum physics within a gaming environment, comprising:
collecting a user input;
determining whether to apply at least one of a portion classical physics to an object within a gaming environment or a potion of quantum physics to an object within the gaming environment;
converting an object to a classical object based at least in part upon the user input;
converting an object to a quantum object based at least in part upon the user input;
updating an object state by at least one of the following:
(i) integrating at least one of a Newton's equation of motion or a Lagrange's equation of motion for the classical object; or
(ii) integrating at least one of an N-body Schoedinger's Equation, a Dirac's Equation, or a wave equation for the quantum object;
detecting a collision and performing at least one of the following:
(i) checking each classical object against each classical object within the gaming environment; or
(ii) performing at least one of Scattering-Theory Computations, Entanglement for Communication, or Action-at-a-Distance for the quantum object in collision with a classical object;
responding to the detected collision with at least one of the following:
(i) applying at least one of a back up of the classical object, a compensating force, or a reactive impulse; or
(ii) collapsing a wave packet to an Eigenfunction for the detected collision between the quantum object and the classical object; and
rendering a scene within the gaming environment by displaying at least one of the classical object or the quantum object.

17. The method of claim 16, further comprising adjusting at least one of an h-bar value or a “c” value associated with a quantum physics equation in order to provide a simulation.

18. The method of claim 16, the gaming environment is at least one of a gaming device, a gaming console, a computer, a desktop machine, a laptop, a smartphone, a device with a portion of memory and a processor, a portable digital assistant (PDA), a hand held, a portable gaming device, an online community, a website, a server, a network, a cloud, or a media player.

19. The method of claim 16, further comprising:
applying a “Multiple-Slit Experiment” effect to an object within the gaming environment as at least one of the offensive tactic or the defensive tactic;
applying a “Collapsing a Wave Packet” to an object within the gaming environment as at least one of the offensive tactic or the defensive tactic;
applying a “Quantum Scattering Theory” to a collision between a first object and a second object within the gaming environment; and
applying a “Quantum Entanglement” to at least one of an in-game communication within the gaming environment, an Action-at-a-Distance, a cryptography, an espionage, or a data storage.

20. A computer-implemented system that facilitates incorporating a combination of classical physics and quantum physics within a computer game, comprising:
means for enabling at least one user to interact with a computer game in order to produce visual feedback;
means for including a simulation that mimics an event in a physical real world within the computer game;
means for utilizing quantum physics as a basis for at least one simulation within the computer game, the simulation within the gaming environment relates to at least one of a projectile, a vehicle, a collision, an explosion, a fantasy element, a magical spell, or a science-fiction weapon;
means for replicating a property associated with realistic quantum mechanics with a portion of the simulation;
means for allowing data communication between the gaming environment and the MQE engine;
means for utilizing classical physics as a basis for at least one simulation within the computer game, the simulation within the gaming environment relates to at least one of a projectile, a vehicle, a collision, an explosion, a fantasy element, a magical spell, or a science-fiction weapon; and
means for adjusting at least one of an “h-bar” value or a “c” value within a quantum physics equation in order to adapt the quantum physics equation to the simulation within the computer game.
